(19) United States
(12) Patent Application Publication
(10) Pub. No.: US 2025/0371096 A1
(43) Pub. Date: Dec. 4, 2025

(54) PERSONALIZED WEBPAGE CONTENT AND LAYOUT SYSTEM

(71) Applicant: Taboola.com Ltd., Ramat Gan (IL)

(72) Inventors: Elad Gov-Ari, Holon (IL); Kurt Gessler, Yorkville, IL (US); Ohad Levy, Meitar (IL); Udaya Manchikatla, La Crescenta, CA (US); Guy Gonen, Beer Sheva (IL); Guy Gilboa, Netanya (IL)

(21) Appl. No.: 19/222,651

(22) Filed: May 29, 2025

Related U.S. Application Data
(60) Provisional application No. 63/653,587, filed on May 30, 2024.
(60) Provisional application No. 63/653,592, filed on May 30, 2024.

(51) Int. Cl. G06F 16/958

(52) U.S. Cl. CPC G06F 16/958

(57) ABSTRACT

A method comprising receiving, by a client device, a webpage from a Content Management System (CMS) with sections arranged in a pre-defined layout. A personalization request to a personalization system is issued. A new content items is received and is used to replace existing items in the webpage. Layout personalization is determined based on computed user affinity levels to both new and non-replaced content. The layout personalization is implemented by modifying the pre-defined layout to a different arrangement of sections, creating a modified layout that differs from the original.

### CROSS-REFERENCE TO RELATED APPLICATION

This application claims the benefit of Provisional Patent Application No. 63/653,587, entitled “CUSTOMIZED HOMEPAGE” filed May 30, 2024, and of Provisional Patent Application No. 63/653,592, entitled “SERVING A PERSONALIZED HOMEPAGE”, filed May 30, 2024, all of which are hereby incorporated by reference in their entirety without giving rise to disavowment.

### TECHNICAL FIELD

The present disclosure relates to serving webpages in general, and more particularly to techniques for personalizing webpages, such as by modifying webpage content, webpage structure, webpage style, or the like.

### BACKGROUND

Internet websites provide users with a wide variety of content. The content may comprise text, graphical elements, title or headline, and the like. Many websites present users with content supplied by a Content Management System (CMS). The CMS may provide content items, which may comprise a title, a body of text, a picture, and other textual and graphical elements. In some cases, the CMS provided webpage may be displayed to the user by a local device, for example a web browser executing on a computing device.

Webpages are typically arranged in a layout of sections, wherein each section typically comprises one or several content items. A content item may comprise one or more elements, for example graphical elements, titles, pictures, bodies of text, and hyperlinks, videos, and the like. In addition, each section may comprise a specific arrangement of how the content item elements are displayed in relation to each other, how much area on the display screen each element covers, and the like.

For many websites, the interests of the visitors to the website may vary significantly. Traditional websites often lack flexibility and remain identical for all users.

### BRIEF SUMMARY

One exemplary embodiment of the disclosed subject matter is a method comprising: receiving, by a client device, a webpage from a Content Management System (CMS) to be displayed to a user, wherein the CMS is configured to generate the webpage to comprise a plurality of sections arranged in a pre-defined layout, wherein each section is associated with a section category, wherein each section comprising one or more content items that are associated with the section category; the client device issuing a personalization request to a personalization system; the client device receiving from the personalization system one or more new content items to replace one or more existing content items in the webpage, wherein the personalization system is configured to select the one or more new content items in response to receiving the personalization request; determining a layout personalization of the webpage based on computed levels of user affinity of the user to the one or more new content items and to one or more non-replaced content items in the webpage; the client device replacing the one or more existing content items in the webpage with the one or more new content items, whereby the webpage is modified to comprise the one or more new content items and the one or more non-replaced content items and to exclude the one or more existing content items; and the client device implementing the layout personalization, wherein said implementing the layout personalization comprises modifying the pre-defined layout to a modified layout, whereby the plurality of sections, or portion thereof, are arranged in the modified layout, the modified layout is different than the pre-defined layout.

Optionally, said determining is performed by the personalization system prior to the client device receiving from the personalization system the one or more new content items.

Optionally, the client device receives the layout personalization from the personalization system together with the one or more new content items.

Optionally, the method further comprises: receiving, by the client device, a second webpage from the CMS; the client device issuing a second personalization request to the personalization system, wherein the personalization system is configured to determine a second layout personalization for the second webpage; upon the client device failing to receive the second layout personalization from the personalization system, the client device displaying the second webpage without modifying an original layout of the second webpage.

Optionally, the client device implementing the layout personalization causes the webpage to not present a new content item from the one or more new content items, whereby a modified webpage that is displayed to the user is absent of the new content item.

Optionally, the new content item is associated with a specific section category, wherein the new content item is not presented by the webpage due to the modified layout comprising fewer content item placeholders to present content items compared to the pre-defined layout with respect to a section that is associated with the specific section category.

Optionally, the new content item is associated with a specific section category, wherein the new content item is not presented by the webpage due to the modified layout excludes a section having the specific section category.

Optionally, the pre-defined layout comprises a first arrangement of the plurality of sections within a screen display, wherein the modified layout comprises a second arrangement of the plurality of sections within the screen display, the second arrangement is different from the first arrangement.

Optionally, the pre-defined layout comprises a number of the plurality of sections, wherein the modified layout comprises a smaller number of sections, whereby the modified layout excludes at least one section that is included in the pre-defined layout.

Optionally, the pre-defined layout comprises a first section associated with a section category, wherein the modified layout comprises a second section associated with the section category, wherein the first section comprising a different number of content item placeholders compared to the second section.

Optionally, the pre-defined layout comprises a first section associated with a section category, wherein the pre-defined layout defines a presentation style for the first section, wherein the modified layout comprises a second section associated with the section category, wherein the modified layout defines a different presentation style for the second section.

Optionally, the presentation style comprises at least one presentation attribute, the presentation attribute is selected from a list consisting of: content item placeholder dimensions; a thumbnail image dimensions within a content item placeholder; vertical or horizontal arrangement of content item placeholders; internal layout within a content item placeholder defining relative position between at least a thumbnail image of a content item and title of the content item.

Optionally, the plurality of sections comprises a hand-curated section, wherein the layout personalization is constrained from changing a presentation style of the hand-curated section and from changing a location of the hand-curated section within the webpage.

Optionally, the method further comprises receiving, by the client device, a second webpage from the CMS, the second webpage comprising at least existing content items, the client device issuing a second personalization request to the personalization system, wherein upon the client device failing to receive new content items in response to the personalization request, the client device displaying the second webpage without replacing the existing content items.

Another exemplary embodiment of the disclosed subject matter is a computerized system comprising: a Content Management System (CMS); a client device of a user; and a personalization system; wherein said CMS is configured to generate a webpage comprising a plurality of sections arranged in a pre-defined layout, wherein each section is associated with a section category, wherein each section comprises one or more content items that are associated with the section category; wherein said client device is configured to: receive the webpage from said CMS to be displayed to the user; issue a personalization request to said personalization system; receive from said personalization system one or more new content items to replace one or more existing content items in the webpage; replace the one or more existing content items in the webpage with the one or more new content items, whereby the webpage is modified to comprise the one or more new content items and one or more non-replaced content items and to exclude the one or more existing content items; and implement a layout personalization by modifying the pre-defined layout to a modified layout, whereby the plurality of sections, or portion thereof, are arranged in the modified layout, the modified layout is different than the pre-defined layout; wherein said personalization system is configured to: select the one or more new content items in response to receiving the personalization request; and determine the layout personalization of the webpage based on computed levels of user affinity of the user to the one or more new content items and to the one or more non-replaced content items in the webpage.

Optionally, said client device is further configured to display the webpage without modifying the pre-defined layout in case of a failure to receive layout personalization instructions from said personalization system in response to the personalization request.

Optionally, the pre-defined layout comprises a first arrangement of the plurality of sections within a screen display, wherein the modified layout comprises a second arrangement of the plurality of sections within the screen display, the second arrangement is different from the first arrangement.

Optionally, the pre-defined layout comprises a number of the plurality of sections, wherein the modified layout comprises a smaller number of sections, whereby the modified layout excludes at least one section that is included in the pre-defined layout.

Optionally, the pre-defined layout comprises a first section associated with a section category, wherein the modified layout comprises a second section associated with the section category, wherein the first section comprising a different number of content item placeholders compared to the second section.

Optionally, the pre-defined layout comprises a first section associated with a section category, wherein the pre-defined layout defines a presentation style for the first section, wherein the modified layout comprises a second section associated with the section category, wherein the modified layout defines a different presentation style for the second section.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows an exemplary flowchart of a method for personalizing content of a CMS served webpage, in accordance with some exemplary embodiments of the disclosed subject matter;

FIG. 1B shows an exemplary flowchart of a method for displaying a CMS webpage without personalizing content in the event of a failure to receive new content items, in accordance with some exemplary embodiments of the disclosed subject matter;

FIG. 2 shows an exemplary sequence diagram of a method for personalizing content of a CMS served webpage, in accordance with some exemplary embodiments of the disclosed subject matter;

FIG. 3A shows an exemplary CMS served webpage prior to personalization, in accordance with some exemplary embodiments of the disclosed subject matter;

FIG. 3B shows an exemplary personalized webpage, in accordance with some exemplary embodiments of the disclosed subject matter; and

FIG. 4A shows an exemplary flowchart of a method for personalizing the layout and content of a CMS served webpage, in accordance with some exemplary embodiments of the disclosed subject matter;

FIG. 4B shows an exemplary flowchart of a method for displaying a CMS webpage with personalized content in the event of a failure to receive layout personalization, in accordance with some exemplary embodiments of the disclosed subject matter;

FIG. 4C shows an exemplary flowchart of a method for displaying a CMS webpage in the event of a failure to receive new content items and failure to receive layout personalization, in accordance with some exemplary embodiments of the disclosed subject matter;

FIG. 5 shows an exemplary sequence diagram of a method for personalizing content items and layout of a CMS served webpage, in accordance with some exemplary embodiments of the disclosed subject matter;

FIG. 6A shows an exemplary CMS served webpage prior to personalization, in accordance with some exemplary embodiments of the disclosed subject matter;

FIGS. 6B-6D show exemplary examples of personalization of a CMS served webpage, in accordance with some exemplary embodiments of the disclosed subject matter;

FIG. 7A shows an exemplary example of a CMS served webpage prior to personalization, in accordance with some exemplary embodiments of the disclosed subject matter; and

FIG. 7B shows an exemplary example of personalization of a CMS served webpage, in accordance with some exemplary embodiments of the disclosed subject matter.

### DETAILED DESCRIPTION

One technical problem dealt with by the disclosed subject matter is how to personalize the content items of a webpage served by a CMS to a specific user. As referred to herein, “user” refers to a person who views a displayed webpage served by a CMS in response to an internet request to download the webpage.

One technical solution provided by the disclosed subject matter may be to generate from a CMS served webpage a personalized webpage. A content item from the CMS served webpage may be replaced with a new content item. The new content item may be selected based on a calculated level of user affinity to the new content item.

In some exemplary embodiments, the disclosed subject matter may comprise a personalization system and a client device that interacts with a CMS and a personalization system. The client device may be a computerized device, such as a Personal Computer (PC), a smartphone, a laptop, a tablet, or the like, that executes a web browser. The client device may be operated by a user. The web browser may be a commercially available browser, for example CHROME™ or FIREFOX™. The web browser may be configured to retrieve a webpage from a web server, such as a server that is configured to serve webpages generated by the CMS. The web browser may be configured to render the webpage and display the rendered result to the user. The web browser may be configured to execute client-side code embedded within the webpage, such as JavaScript™ code.

In some exemplary embodiments, the personalization system may be a server located remotely from the client device, for example hosted on a cloud platform, hosted on a web server, hosted on a computer accessible through the Internet.

In some exemplary embodiments, Client-side code within the webpage may be tasked with handling personalization. In some cases, in response to a webpage being retrieved (e.g., the user issuing a command to browse to a specific website), the client device may execute the client-side code to perform the personalization. In some exemplary embodiments, the webpage may comprise indications from the CMS regarding content items, for example an indication that a content item is replaceable, an indication that a content item is not replaceable, referred to herein as “hand-curated”, or the like. The indications may be instructions from the CMS to the client device. As an example, replaceable content item indication may indicate that the associated content item may be replaced with a different content item by the client device during the personalization process. As another example a hand-curated content item may indicate that the associated content item may not be replaced by the client device during the personalization process.

In some exemplary embodiments, the client device may identify a content item as replaceable, for example based on the CMS indications, and may obtain a new content item to replace the replaceable content item in the webpage. The new content item may be selected from a content repository of the personalization system. The content repository of the personalization system may be a repository of content items that may be made available to a client device for replacing CMS served content items. In some exemplary embodiments, the selection may be performed locally by the client device. Additionally, or alternatively, the selection may be performed by the personalization system in response to a command issued by the client device.

In some exemplary embodiments, the selection of the new content item may be based on a computed level of affinity of the user for the new content item. For example, the client device may retain information associated with the user, for example information regarding user interactions with content items, webpage browsing history, dwell time, demographic information of the user, behavioral information regarding the user, and the like. Using the user-based information, user affinity to a new content item may be calculated. In some cases, affinity may be calculated based on observed activity of similar users, such as having the same characteristics (or portion thereof) as the user. The observed activity may be obtained by client devices of other users over time, and may be retained by the personalization system.

In some exemplary embodiments, the client device may replace in the webpage one or more replaceable content items with the new content items received from the personalization system in response to a personalization request from the client device. As a result of one or more such replacements, the client device may generate a personalized webpage. The personalized webpage may differ from the webpage received from the CMS in that the personalized webpage may comprise the new content item, and may exclude the replaceable content item. In some exemplary embodiments, the personalized webpage may be rendered and displayed by the user device.

In some exemplary embodiments, in case more than a single content item is being replaced within the webpage, the relative location of the new content items that are selected for the personalization may be determined based on a calculated score. The score may be calculated based on information regarding the user and based on information relating to the content item. In some cases, a higher score may reflect an estimated greater user affinity to the content item. Accordingly, higher-scored content items may be placed in better positions within the webpage, such as in higher locations within the webpage. In some exemplary embodiments, score-based sorting of content items selected by the personalization system may be limited to within the same category.

One technical effect of the disclosed subject matter may be to reduce web traffic generated by users who have been served webpages by a CMS, whereby due to lack of user affinity with the content items, the user may search for content items of interest by requesting the CMS to serve additional pages.

Another technical effect of the disclosed subject matter may be to enhance a user experience of viewing a web page, for example by replacing content items of a CMS served webpage with a new content item based on calculated user affinity in a manner that is transparent to the user and requires no user input.

Yet another technical effect of the disclosed subject matter may be to provide a personalization system that is CMS-agnostic. The personalization system is not required to have a direct interface with the CMS. In some cases, the personalization system is therefore able to enable personalization of different websites using different CMSs without requiring an Application Programming Interface (API) to be available or used. In some cases, as no API is used, integration between the CMS and personalization system is performed seamlessly and without requiring extensive development resources and quality assurance procedures.

Another technical problem dealt with by the disclosed subject matter is preventing an interruption to the user experience of viewing a webpage as a result of a failure in the personalization process. A naïve personalization solution may be to provide a webpage without the original items that would be replaced. In such a naïve solution, the CMS may serve a webpage that only includes the hand curated items and placeholders for personalized items. However, in such a naïve solution, when there is a failure to obtain the personalized items, be it due to network communication issues, server shutdown events, not having any relevant content items in the repository, or the like, the webpage that is displayed to the user would be incomplete. For example, a failure may occur in a process of a new content item selection. When a new content item may fail to be obtained, the process of replacing a content item may be halted, thereby effectively freezing the display prior to rendering and displaying the requested webpage or the personalized webpage.

In some exemplary embodiments, in case of a failure to receive a new content item, the CMS-served webpage may be rendered and displayed to the user by the client device.

Another technical solution provided by the disclosed subject matter may be to configure the client device to render and display to the user the CMS-served webpage in the circumstance that the new content item is not received in a timely manner. For example, the client device may be configured to render and display the CMS served webpage when the obtaining of the new content item is delayed by a number of seconds, such as 0.001 second, 0.1 second, 0.5 second, 1 second, 5 seconds, 10 seconds or the like. In the circumstance that the new content item is obtained with a delay of less than the number of seconds, the client device may be configured to render and display the personalized webpage to the user. In some cases, after the original CMS-served webpage is rendered and displayed, the display may be updated in response to receiving and rendering of new content items from the personalization system.

Yet another technical effect of the disclosed subject matter may be to provide a robust system that enables content personalization on the one hand, but does not negatively affect the user experience in cases of malfunctions. The disclosed subject matter enables the user device to present a non-personalized webpage for the user when the personalization system experiences technical difficulties in providing new content items to the client device. The disclosed subject matter may enable the user to continue consuming content provided by the CMS when there's no connectivity to the personalization system, such as due to server malfunction or communication issues.

Yet another technical problem dealt with by the disclosed subject matter is acquiring new content items to be available for replacing CMS served content items. One naïve solution may be to integrate the personalization system with the CMS. In such a solution, the personalization system may utilize the content inventory of the CMS itself. However, such a solution requires an integration between the CMS and the personalization system. In such a solution, the personalization system would not be CMS-agnostic, and specific development efforts would be required to integrate the personalization system with different CMS systems.

A naïve solution in which the personalization system is not integrated with the CMS and does not have any interface therewith, may be to perform blind crawling of the relevant website. In such a solution, the personalization system may crawl the website to locate the new content items. For example, a personalization system may acquire new content items by “blind crawling”, which refers to herein as serially inspecting every available content item, for example content items served to a client device by a CMS. Blind crawling may consume time and resources of the personalization system.

Yet another technical solution of the disclosed subject matter may be to configure the client devices such that when the users visit webpages, information related to content items encountered by the client device in visited webpages are transmitted to the personalization system. The information may comprise, for example, time of publication, date of publication, a category associated with the content item, a headline or title, a link to the content item, a saved version of the content item, text content, media files, images, video, audio, metadata related to media and other files. The metadata may comprise for example file size, resolution, format, duration, language, relevant permissions or access levels, version history, engagement data, interaction data, file path location, and the like.

In some exemplary embodiments, the personalization system may comprise a content item repository for storing the information transmitted from the client devices, the associated content items, or the like. The personalization system repository may be a source of new content items obtainable by the client device in the personalization process.

It is noted that such a solution may provide a partial repository of the content items of the CMS. If a certain content item was not yet served to any specific user, the disclosed subject matter may be unaware of its existence and would not be able to select it as part of the personalization process. However, assuming there as a large number of users consuming content from the website, it is a reasonable assumption that newly released content items would be encountered by client devices within a relative short time of their publication, and therefore become available for the personalization system.

In some exemplary embodiments, the personalization system may be configured to selectively update the personalization system repository based on information received from the client device. In some exemplary embodiments, when a client device encounters a content item, the client device may report the information to the personalization system. The personalization system may determine whether the same content item was previously encountered. In case the content item was never encountered before, the personalization system may retain the content item information in a content repository. Additionally, or alternatively, if the content item was encountered previously, the personalization system may determine whether to update the information or not. In some exemplary embodiments, an aspect of the content item may be updated. For example, title, sub-title, media file, publication date, publication time, URL, or the like. The content repository may be updated to reflect the change in the content item. As an example, an article published by a CMS may have an original publication date and time. In some cases, if the article is updated, the publication date and time may be updated or a different metadata field (e.g., “update time” field) may reflect the time of update. Based on such information, the personalization system may determine whether to update an already existing content item in its content repository. Additionally, or alternatively, when a previously encountered content item is encountered again, the current title may be compared to the previously encountered title. For example, in a sport match, the title of a content item that covers the match, may be dynamically updated as the match progresses. In such a case, the content item may be updated. As yet another example, when a previously encountered content item is encountered again, the media that accompanies the content item (e.g., thumbnail) may change. The content item repository may be updated to reflect the updated media.

In some exemplary embodiments, the content item may be encountered in one presentation style and be served to be used in a second presentation style. For example, the content item may be encountered in a placeholder that includes a place in which the title and the sub-title can be presented. When served, the same content item may be placed in a placeholder having different dimensions, having no place to display the sub-title, or the like. As another example, the media file may be displayed as a thumbnail in one presentation style, and may be presented as a large image in a second presentation style. As yet another example, the media file may be presented in a different relative position to the title in different presentation styles.

Yet another technical effect of the disclosed subject matter may be to make the process of acquiring new content items more efficient, thereby conserving computing resources, for example graphics processor, a processing unit, Internet communication bandwidth, or the like. The naïve system, seeking to acquire new content items, would initiate Internet communication with a large number of webpages, searching each webpage, and possible linked webpages as well, for new content items. Utilizing user web browsing as a passive means of acquiring content items and associated information may reduce the use of computational and communication resources, thereby reducing web traffic and potentially improving internet response times. It is also noted that the computational resources of the end user are leveraged for the benefit of the owner of the personalization system.

Yet another technical problem dealt with by the disclosed subject matter is enabling a client device to personalize webpages served by a plurality of mutually incompatible CMSs. Integrating the personalization system with different CMSs would require the use of dedicated APIs or to otherwise integrate the personalization system with each different type of CMS. Instead, a CMS-agnostic personalization system may be desired.

Yet another technical solution provided by the disclosed subject matter may be avoiding a direct interface between the CMS and the personalization system. The client device may receive a webpage from any CMS, whereas receiving a webpage is performed using standard and virtually universal protocols implemented in the client device, irrespective of the CMS API. The client device may be configured to extract updates and other relevant information from CMS served input, and forward the information to the personalization system. Accordingly, in some embodiments of the disclosed subject matter, the personalization system does not communicate directly with the CMS. This renders the personalization system agnostic regarding the CMS. The personalization system may comprise a content repository that includes the content repository of the CMS or portion thereof. The personalization system may utilize its content repository, and not the content repository of the CMS, when performing content item selections for the personalization process.

Yet another technical effect of the disclosed subject matter may provide for a personalization system that is CMS-agnostic and which may be implemented on any website regardless of the CMS being used to serve its webpages. The solution increases system modularity and scalability by decoupling the personalization system from the CMS, while simplifying integration with multiple CMSs. This reduces development overhead otherwise required to create capabilities to interface directly with each specific CMS system, and enhances flexibility to deploy the personalization system with a variety of CMS systems.

Yet another technical problem dealt with by the disclosed subject matter is avoiding irrelevant or stale recommendations which may result from selecting personalizing content items without regard to category or timeliness of the content item. Without using category and publication time, the system may degrade the user experience by serving new content items that are outdated, off-topic, or the like.

Yet another technical solution provided by the disclosed subject matter may comprise the selection of new content items based on a category that matches the category of the replaceable content item. For example, the personalization system may obtain category information regarding a category of a replaceable content item, for example from the client device, from the CMS, from a service that is adapted to supply a category of content items, from a database of content items and associated categories, or any other source. The personalization system may use the obtained information to obtain from a content repository of the personalization system a content item whose category matches the category of the replaceable content item.

Additionally or alternatively, according to some embodiments of the disclosed subject matter, the selection of the new content item may be based on publication date. For example, a time window for displaying a content item may be limited to a period of time after original publication in order to avoid serving content items that lack interest for users due to a lack of currency. For example, a time window for a content item belonging to a category such as news, current events, financial markets, and the like may be calculated or obtained to be 12 hours, one day, three days, seven days, ten days, or the like. In another example, a different time window may be calculated or obtained for content items associated with a different category. For example, a time window for a content item belonging to a category such as recipes, science, travel, and the like may be calculated or obtained to be one week, several weeks, or the like.

In some embodiments of the disclosed subject matter, the time window for a given category may be responsive to a specific user, and may vary depending on the specific user.

Yet another technical effect provided by the disclosed subject matter may comprise reducing web traffic by serving content items that are both timely and topical for a user, thereby improving the user experience and reducing the likelihood that the user will navigate away from the webpage to a different webpage. In addition to reducing web traffic, the user local platform may have a lower computation load, thereby reducing processing time in displaying content.

Yet another technical solution provided by the disclosed subject matter may comprise the client device sending a request to the personalization system, whereas the client device request may be configured to include inputs regarding the user. The personalization system may be configured to select a new content item based on the client device request.

In some exemplary embodiments, the personalization system may be configured to base a selection of a new content item based on the inputs regarding the user, for example inputs received from the client device, from third parties, or any combination thereof. A score to reflect user affinity for the new content item based on the received inputs may be calculated by the personalization system, a third party, or any combination thereof.

In some exemplary embodiments, inputs of the calculation may comprise, for example, user profile data, for example browsing history, preferences, demographics, location, or any combination thereof. Inputs may comprise for example user behavioral data, for example search engine queries, browsing history, demographic information, engagement patterns, and the like. Inputs may comprise for example user technical data, for example IP address, IP metadata, device type, browser type and version, and the like. Inputs may comprise, for example, social media context, for example social media posts, mentions, trending status, contextual data, for example source website, domain authority, related articles, user engagement metrics regarding other content items, for example views, likes, shares, average dwell time, and the like.

In some exemplary embodiments, inputs may comprise, for example, metadata, for example title, author, publication date, tags, categories, keywords, topics or categories, presence or absence keywords or specific terms indicating an alignment with user interests, publisher, language and style for example complex vs. simple sentence structure, casual vs. academic style, number of comments, click through rates, ratio of favorable and unfavorable comments, engagement metrics, for example views, likes, shares, average dwell time, and the like.

In some exemplary embodiments, the selecting of a new content item may further comprise extensive database queries, for example to the content repository of the personalization system, in order to calculate a user affinity score for potential new content items. While the personalization system may be hosted by a server computer platform configured to perform the actions described above, the user client device computing platform may be a slim computational platform in comparison, such that task of selecting the new content item may introduce unacceptable delays, or even a complete loss of responsivity.

Yet another technical effect of the disclosed subject matter may be to enable the client device to provide an acceptable user response time to a user request to display a web page by offloading to the personalization system the computationally intense and time-consuming task of computing a score reflecting user affinity for a new content item.

Yet another technical problem dealt with by the disclosed subject matter may be that conventional CMS-driven webpages lack of adaptability to individual user preferences and inability to dynamically tailor webpage content items, layout, or both. CMS driven systems typically do not personalize the layout of a webpage. For example, a webpage layout may comprise sections associated with categories or topics, where a more prominent location on the webpage may be occupied by a category of little interest to a specific user. In addition, diverse client devices with varying screen sizes and contextual usage may require dynamic reordering of webpage layout. In many cases, a static layout is manually determined and utilized for index webpages, such as a homepage, a category main page, or the like. The index webpage may include links to other content pages. The index webpage may therefore include a plurality of content items, each of which providing a summary of the content page itself. For example, the content item may include the title and an image that is representative of the content page. In some cases, the content item may include sub-title or other additional information. The content item may be linked, such as using a hyperlink, to a URL of the content page.

A technical solution dealt with by the disclosed subject matter may be a hybrid client-server architecture for personalization of webpages for users. The personalization system may enable the personalization of a layout of the webpage. The layout may be personalized based on computed user affinities.

In some exemplary embodiments, the client device may receive a CMS-generated webpage with a pre-defined layout comprising multiple sections. Each section may be associated with a category. Each section may comprise at least one content item associated with the section category. The client device may then issue a personalization request to a personalization system. The personalization system, in response to the request from the client device, may select one or more new content items intended to replace one or more existing content items, and include the selected new content items in a response to the client device.

In some exemplary embodiments of the disclosed subject matter, based on user affinity metrics computed for the new content item, content items served by the CMS system, or any combination thereof, the client device may implement a layout personalization. The layout personalization may change the layout of the webpage. The layout personalization may alter the number, arrangement, visual formatting, or any other parameter, of the sections in comparison with the pre-defined layout received from the CMS, thereby modifying the pre-defined layout into a modified layout.

In some exemplary embodiments of the disclosed subject matter, the modified layout may comprise one or more new content items. The modified layout may exclude one or more existing content items, for example content items that were served by the CMS. For example, new content items may replace existing content items. Additionally, or alternatively, new content items may be added in addition to existing content items. Additionally, or alternatively, existing content items may be removed without being replaced by another new content item. In some embodiments, the number of new content items may be greater than, less than, or equal to the number of excluded existing content items.

In some exemplary embodiments of the disclosed subject matter, the personalization system may comprise a content repository comprising a storage of content items that may be served to a client device. The personalization system may be configured to select specific new content items based on the personalization request received from the client device.

In some embodiments of the disclosed subject matter, the client device personalization request may comprise information related to the user, thereby enabling the personalization system to select new content items based on a calculated affinity of the user to a new content item.

In some exemplary embodiments, the personalization system may be assigned the task of determining the layout personalization. While the client device may be tasked with implementing the modified layout, the client-server architecture enables the personalization system to determine the modified layout, whereas the client device may obtain the modified layout from the personalization system. For example, the personalization system may transmit together or separately new content items and a modified layout to the client device.

A technical effect dealt with by the disclosed subject matter is a means to personalize both webpage content and webpage layout personalization at the client level, enabling dynamic reorganization of sections and selective content replacement. The client-server reduces the load on the CMS server by offloading personalization and layout computation to either the client device or the personalization system.

The personalization of layout may also minimize web traffic by locating sections of greater user interest in high visibility locations thereby engaging with user interests, thereby reducing user-initiated churn of web pages. In some embodiments, improved user engagement through relevance-based layout structuring supports retention of users, longer dwell time, and greater user interaction with content, for example comments, user ratings, sharing of content, and the like.

Additionally, or alternatively, the disclosed subject matter may achieve an improved and potentially optimal usage of the screen display real-estate. This improvement may be achieved by modifying the layout to be personalized for a specific user in view of the currently available content items.

Yet another technical effect dealt with by the disclosed subject matter may be to limit client device complexity and processing load by offloading to the personalization system the determining of the modified layout.

Yet another technical problem dealt with by the disclosed subject matter is ensuring that a failure of the personalization system does not negatively impact the user experience.

Yet another technical solution dealt with by the disclosed subject matter may comprise configuring the client device to detect that in response to new content items not being received within a defined threshold of time, rendering and displaying the CMS served webpage without replacing CMS-served content items. Additionally, or alternatively, layout personalization response may not be timely received. In some cases, the disclosed subject matter may therefore avoid implementing any layout personalization and instead utilize the pre-defined layout. In some exemplary embodiments, if a personalized layout instruction is received after a predetermined time duration, the disclosed subject matter may avoid implementing the layout personalization, as layout personalization may be considered potentially disruptive to the user's experience after the user had started to consume the webpage. This is in contrast to content item personalized, which may be considered less disruptive and may be performed after the predetermined time duration.

In some embodiments of the disclosed subject matter, the client device may receive the response to the personalization request in a timely manner, the client device may be configured to determine a response that fails to conforms to pre-defined standards, and in that case to render and display the CMS served webpage in place of the modified webpage. For example, the client device may determine that the personalization system response comprises corrupted files, inappropriate files, unreadable files, or the like.

Yet another technical effect dealt with by the disclosed subject matter is to enhance the robustness of the personalization system, ensuring a continuous user experience and reducing latency by reverting to a baseline of displaying the CMS served webpage in failure scenarios.

Yet another technical problem dealt with by the disclosed subject matter may be resolving incompatibility between a modified layout and one or more new content items. The incompatibility may stem from the modified layout reducing or changing the number of content items or new content items that can be accommodated in a given section. For example, the pre-defined layout may comprise a section that accommodates four content items, and the same section in the modified layout may accommodate three content items.

Yet another technical solution dealt with by the disclosed subject matter may be for the client device to calculate or obtain a distribution of new content items within modified sections of the modified layout. For example, the client device may determine based on a score of user affinity associated with the new content items which specific new content item or items are to be excluded from the modified layout.

In some embodiments of the disclosed subject matter, the client device may comprise functionality configured to remove one or more new content items from a modified layout. For example, the pre-defined layout may accommodate three content items where each content item comprises a thumbnail picture as well as title text, and the same section in the modified layout may accommodate the text titles but not the thumbnail pictures, such that the content items may all be displayed, but the thumbnail pictures may be excluded. For example, a section in the pre-defined layout may accommodate four content items, and the same section in the modified layout may accommodate five content items whereas the client device may have received two new content items for the section, along with instructions not to replace any of the existing content items in the same section, such that one of the two new content items will not be displayed.

In some embodiments of the disclosed subject matter, the client device may compute or receive a determination to remove one or more new content items from a modified layout. The determination may be performed based on user affinity for new content items, a spatial calculation configured to finding a solution to altering new content items to meet spatial or graphical constraints of a section, a calculation of relevancy of new content items influenced by current or historical events, or the like.

In some embodiments of the disclosed subject matter, the client device may exclude a new content item due to the modified layout reducing the number of placeholders for content items in a section associated with the specific category to which the new content item is also associated. In another example, the new content item may be associated with the same category as a section that is excluded in the modified layout, resulting in the exclusion of the new content item from the modified webpage that implements the modified layout.

Yet another technical effect dealt with by the disclosed subject matter may be provide a wide degree of discretion in determining a modified layout, thereby providing a relatively large set of possible layout modifications, thereby increasing the likelihood of determining an optimal layout modification which may increase user affinity to the content items presented in the modified layout.

Yet another technical problem dealt with by the disclosed subject matter may be that pre-defined layouts may contain sections that lack relevance to a specific user, contributing to churn of web pages, wasting screen display real-estate and consumption of client and server resources.

Yet another technical solution dealt with by the disclosed subject matter may be configuring the determining of the modified layout to exclude from the modified layout one or more sections from the pre-defined layout, for example based on a computed low level of user affinity (e.g., below a threshold) to the category associated with the excluded section or sections, based on a computed low level of user affinity to the content items to be displayed within the category, or the like.

Yet another technical effect dealt with by the disclosed subject matter may be to reduce user churn of webpages by enhancing user interest regarding the modified layout in comparison to the pre-defined layout, which may channel user attention towards section categories of affinity to the user by eliminating alternative sections with lower computed user affinity.

Yet another technical solution dealt with by the disclosed subject matter may be to provide for dynamic allocation of the number of content items in a webpage section, for example, based on user affinity. In some exemplary embodiments, the determination of the modified layout to increase or decrease the number of content item placeholders in a section may be based on the different factors. The different factors may be the associated category and on a computed level of user affinity to the category. Additionally, or alternatively, the different factors may be user affinity to the specific content or new content item. For example, a low computed level of user affinity to a category associated with a section may result in reducing the number of content item placeholders in the modified layout compared to the pre-defined layout. As another example, a high computed level of user affinity to a category associated with a section may result in increasing the number of content item placeholders in the modified layout compared to the pre-defined layout. It is noted that the terms “high” and “low” are relative and can be determined based on a comparison to a threshold value, be it absolute threshold value or relative threshold value.

In some exemplary embodiments, a pre-determined layout may comprise a presentation style of content items in a section. The modified layout may include a modification of a style of sections. The style modification may be based on user affinity to the category associated with the relevant section.

In some exemplary embodiments of the disclosed subject matter, a presentation style of a content item may comprise an attribute that determines for example the dimensions of a content item placeholder of all content items within the section. The original dimensions of a content item to be placed within the section may need to be modified to conform to the required dimensions of the section. The attributes of presentation style may include content item placeholder dimensions. Additionally, or alternatively, the attributes of presentation style may include the presence or lack of an image, for example a thumbnail photo, a graphic symbol, a logo, or any combination thereof. Additionally, or alternatively, the attributes of presentation style may include an arrangement of content item placeholders within the section, for example a number of content items per row, a number of content items per column, or any combination thereof. Additionally, or alternatively, the attributes of presentation style may include an arrangement of components of the content item within the content item placeholder, for example defining relative positions between a thumbnail image, a title, a text, a hyperlink, a video, an animation, a graphic element, a publication date, or any combination thereof.

In some exemplary embodiments, the modification of a presentation style of a placeholder may be based on user affinities, for example adding a thumbnail image to the presentation style of one or more content item placeholders in a section with a high calculated level of user affinity, removing a thumbnail image from the presentation style of one or more content item placeholders in a section with a low calculated level of user affinity, and the like.

In some exemplary embodiments, the modification of a presentation style of a placeholder may be uniform for a group of placeholders, for example a group of placeholders arranged horizontally along a row or the like may share the same presentation style. In some exemplary embodiments, the modification of a presentation style of one or more placeholders may differ from other place holders in a section, for example a placeholder may include a thumbnail photo or other content item element that may be lacking in some or all of the remaining placeholders in a section.

Yet another technical effect dealt with by the disclosed subject matter may be to improve user engagement by fine-tuning visual and spatial formatting of content items based on user affinity.

In some exemplary embodiments, the determination of layout modification may be configured to be responsive to an indication that certain sections, content items, or both, are not available for modification. For example, a webpage served by a CMS may comprise one or more content items, one or more sections, or any combination thereof, that are indicated not to be modified, replaced, or changed in any way. Such content items, sections, or any combination thereof may be designated as “hand-curated”, meaning they are not to be modified in content or layout location. In some embodiments of the disclosed subject matter, a section, content item, or any combination thereof, may be indicated to be hand-curated regarding some aspects, and in other aspects may be modified. For example, a section may be indicated to be partially hand-curated. For example, one or more aspects may be hand-curated, for example the location of the section within the layout may be hand-curated, but other aspects may be indicated not to be hand-curated, for example the presentation style of the content items of the section may be available to be modified.

Yet another technical effect dealt with by the disclosed subject matter may be to allow a level of editorial control of a webpage, for example by a CMS, thereby maintaining a level of consistency between different webpages, the same webpage over time, or both. A website consisting of a plurality of webpages may enhance user affinity by maintaining among webpages a common style, which may be accomplished by limiting personalization of the plurality of web pages to non-hand-curated aspects.

Yet another technical problem dealt with by the disclosed subject matter is ensuring that a failure of the client device to receive a modified layout from the personalization system does not negatively impact the user experience.

Yet another technical solution dealt with by the disclosed subject matter may comprise configuring the client device to detect that in response to a layout personalization not being received within a defined threshold of time, rendering and displaying the CMS served webpage in place of the modified webpage.

In some embodiments of the disclosed subject matter, the client device may receive the response to the personalization request in a timely manner, however the client device may be configured to determine that the received response fails to conforms to pre-defined standards, whereupon the client device may render and display the CMS served webpage in place of the modified webpage. For example, the client device may determine that the personalization system response comprises corrupted files, inappropriate files, unreadable files, or the like.

Yet another technical effect dealt with by the disclosed subject matter is to enhance the robustness of the personalization system, ensuring a continuous user experience and reducing latency by reverting to a baseline of displaying the CMS served webpage in layout failure scenarios.

The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

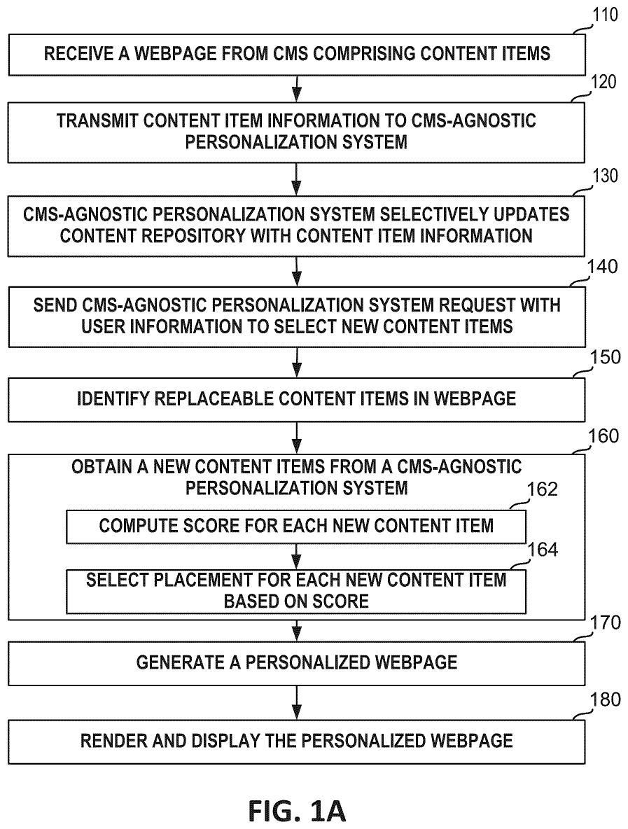

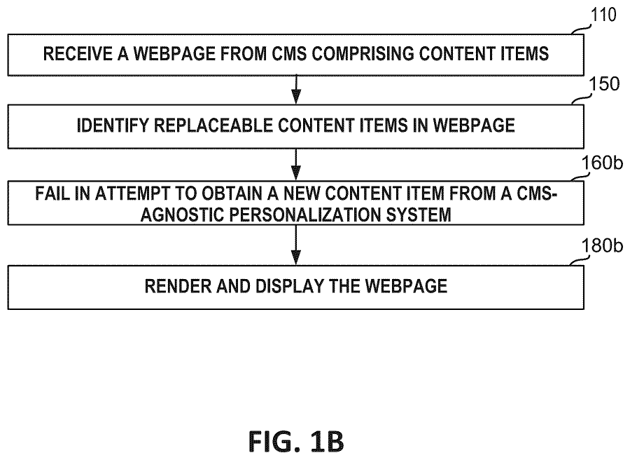

Referring now to FIG. 1A, depicting an exemplary flowchart of a method of content personalization, in accordance with some exemplary embodiments of the disclosed subject matter. This figure illustrates the sequence of actions executed by the client device and the personalization system to personalize content items of a CMS-served webpage. It includes receiving the webpage from a CMS, identifying replaceable content items, issuing a personalization request to a CMS-agnostic personalization system (CMSAPS), and replacing one or more content items based on computed user affinity.

In Step 110, a client device receives a webpage from a CMS. The webpage comprises content items including hand-curated and replaceable content items.

In Step 120, the client device may transmit content item information to a CMS-agnostic personalization system, enabling the CMSAPS to retain information regarding content items that were presented by the CMS. This information may be received before new content is selected, which may enable the system to choose new content items based in part on the content items served by the CMS.

In Step 130, the CMSAPS may update its content repository based on the information sent in Step 120. The CMSAPS may employ the content item information received from the client device to selectively update a content repository.

In Step 140, the client may send a request to the CMSAPS that includes user-specific information, enabling selection of new content items based on information related to the specific user. In some embodiments of the disclosed subject matter, the user-specific information of Step 140 and the content item information of Step 120 may be transmitted in a single message.

In Step 150, the client device may identify which content item is indicated as replaceable and which is indicated as hand-curated. In some exemplary embodiments, the client device may identify content items tagged as replaceable content items in the CMS served webpage. Additionally, or alternatively, the client device may identify content items tagged as hand-curated are identified in the CMS served webpage.

In Step 160, a new content item is obtained from the personalization system. The new content item may be selected specifically for the user (e.g., a personalized selection). In some exemplary embodiments, the selection may be made by the client device. Additionally, or alternatively, the selection may be made by the CMSAPS and transmitted to the client device for display. In some exemplary embodiments, new content items may be selected from the content repository of the CMSAPS and may be limited to content items that could be displayed as part of the webpage. For example, the content repository may retain sponsored content items as well as organic content items of different publishers. In a webpage owned by a certain publisher, only organic content items of that publisher and sponsored content items may be presented. In some exemplary embodiments, the new content item may be obtained based on computed user affinity to the new content item. As an example, the content item with the highest user affinity may be selected.

In Step 162, a score may be computed for each new content item. The score may be a score indicative of user affinity to the respective new content item. The content items for which the score is computed may be content items retained in the content repository of the CMSAPS. Additionally, or alternatively, the score may be computed only for potential content items that can be selected, such as recent content items, content items of the same category as a content item being replaced, organic content items of the same publisher, or the like. In some exemplary embodiments, using the computed scores, the potential new content items may be ranked from top-ranking to bottom-ranking.

In Step 164, based on the score-based ranking of the new content items, a subset of the new items may be selected. Additionally, or alternatively, a placement within a section of each new content item in the subset may be determined. In some cases, higher ranking content items may be placed in more prominent placements such as higher in the webpage.

In Step 170, the client device generates the personalized webpage. The personalized webpage may incorporates the new content items and CMS-served content items. In some exemplary embodiments, the personalized webpage may implement the placement decisions of Step 164.

In Step 180, the personalized webpage may be rendered and displayed to the user. The client device may render the personalized webpage. Additionally, or alternatively, the webpage may be displayed using a display of the client device.

Referring now to FIG. 1B, depicting an exemplary flowchart of handling failures in content personalization, in accordance with some exemplary embodiments of the disclosed subject matter. FIG. 1B depicts a failure scenario where the client device attempts but fails to obtain a replacement content item. It highlights the system's fallback behavior: displaying the CMS-served webpage without performing a content substitution. In some cases, FIGS. 1A and 1B may be performed in sequence where in some cases FIG. 1A is implemented and in others, when a failure occurs, FIG. 1B is implemented.

The method of FIG. 1B starts with Step 110. It is noted that in some embodiments, Steps 120-140 may also be performed before implementing Step 150.

In Step 160b, an attempt to obtain new content item fails. This is in contrast to Step 160 in which the new content item is successfully obtained. The new content item may not be obtained due to many different reasons. Some non-limiting potential reasons could be: connectivity issues with the CMSAPS, the CMSAPS being inoperative or unresponsive, the content repository of the CMSAPS being offline, or the like.

In Step 180b, the CMS served webpage is rendered and displayed to the user without personalization. It is noted that in some embodiments, the CMS-served webpage is initially rendered and displayed, and only after which there is an attempt to obtain new content items (be it successful, Step 160, or unsuccessful 160b). For example, in some cases, the browser of the client device may render the CMS-served webpage. As part of the rendering of the CMS-served webpage, client-side code within the CMS-served webpage may be executed. Such client-side code may initiate the attempt to obtain the new content item. For example, the client-side code may cause the client device to instruct the CMSAPS to provide new content items as part of the personalization process. In some cases, the client-side code may cause the client device to gather the information that identifies the user's characteristics and provide such information to the CMSAPS, as part of a personalization request.

In some exemplary embodiments, in response to Step 160b, the client device may, instead of displaying the CMS-served webpage, access an alternative new content item, for example a locally cached new content item from a previous iteration, a content item stored from a previous CMS-served webpage, a content item extracted from another webpage, or any combination thereof, and proceed with the personalization method as described in FIG. 1 in Steps 160, 162, 164, 170, and 180.

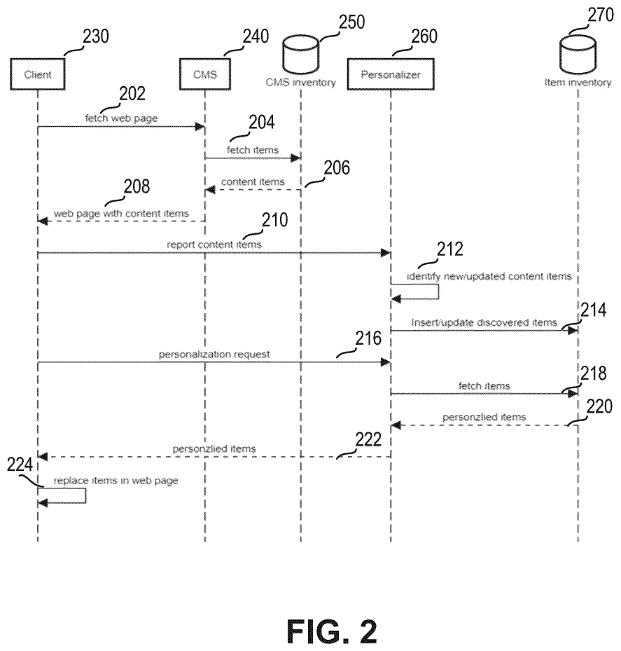

Referring now to FIG. 2 showing a sequence diagram for content personalization, in accordance with some embodiments of the disclosed subject matter. This sequence diagram illustrates interactions between client device, CMS, CMS inventory and personalization system. It depicts request and response exchanges: the CMS may deliver a webpage with replaceable content, and the client may interact with a personalization system to obtain new content items.

As shown in FIG. 2, Client Device 230 may send “fetch web page” message (202) to CMS 240 requesting a webpage. CMS 240 may send “fetch item” message (204) to CMS repository 250 requesting content items. CMS Repository 250 may respond with Message 206 comprising content items. CMS 240 may compile the webpage using the content items received in Message 206. CMS 240 sends the webpage to Client Device 230 in Message 208. In some embodiments, the CMS-served webpage may include additional information, for example embedded in the webpage, to assist in identifying replaceable content and hand-curated content.

Client Device 230 may receive the webpage and render it to be displayed. The webpage may include client-side code causing Client Device 230 to issue requests useful in accordance with the disclosed subject matter.

In some exemplary embodiments, the client-side code may cause Client Device 230 to report content items that it encountered in the webpage. Message 210 (“report content items”) may be sent to Personalization System 260 with information regarding the content items included in the web page.

Personalization System 260 may identify content items that are new or updated (212). For example, Personalization System 260 may check whether the same URL is already included in a content item in Item Inventory 270. Additionally, or alternatively, Personalization System 260 may determine whether an existing content item within Item Inventory 270 should be updated in view of the newly reported content item. As an example, hash value of the URL may be computed to determine whether the same content item was previously encountered and introduced to Item Inventory 270. The hash value of the updatable information may also be computed and compared to a previously computed hash value to determine whether the same content item needs to be updated based on the new information. In some cases, Personalization System 260 may retain a hash table, Bloom Filters, or other similar data structures that are useful for the determinations made in Step 212. It is noted that the disclosed subject matter is not limited to the use of hash values and other techniques may be implemented. In case a new content item needs to be inserted to the repository, or an existing content item needs to be updated, Message 214 may be transmitted and the item may be inserted or updated in Item Inventory 270.

Client device 230 may send Personalization Request 216 to Personalization System 260. Personalization Request 216 may comprise information regarding the CMS-served webpage. Personalization System 260 may send a Content Item Fetch Request 218 to Item Inventory 270. The relevant items may be fetched (220). The Personalization System 260 may select items to be served to Client Device 230. In some exemplary embodiments, Personalization System 260 may compute scores or otherwise determine user affinity to the different content items. The content items to be displayed to the user are transmitted in Message 222.

In Step 224, Client Device 230 may replace one or more content items from the CMS-served webpage with new content items received from Personalization System 260.

In some exemplary embodiments, the Personalization System 260 may provide a ranking of the new content items (transmitted in Message 222). The Client Device 230 may utilize the ranking to determine placement of each new content item.

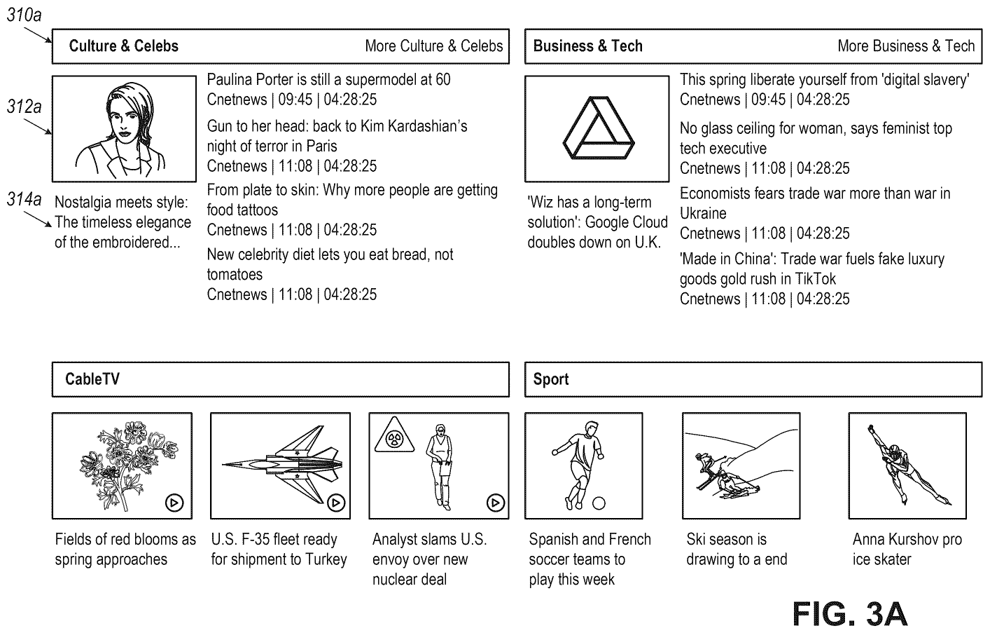

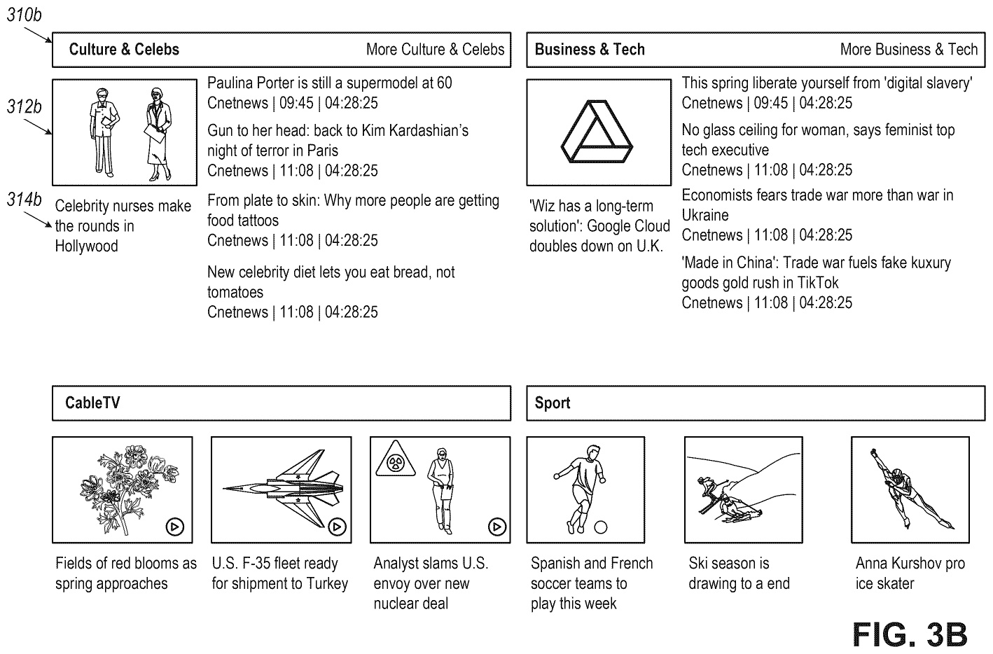

Referring now to FIG. 3A, a sample webpage served by a CMS to a client device, in accordance with some exemplary embodiments of the disclosed subject matter. FIG. 3A shows Section 310a. Section 310 includes many content items, one of which has a Thumbnail Image 312a and Title 314a.

Referring now to FIG. 3B a personalized webpage, accordance with some exemplary embodiments of the disclosed subject matter. FIG. 3B depicts the same webpage after an exemplary personalization. Section 310b includes a replacement content item instead of the one shown in FIG. 3A. The new content item comprises Thumbnail Image 312b and Title 314b. Thumbnail Image 312b replaces Thumbnail Image 312a in FIG. 3A. Title 314b replaces Title 314a in FIG. 3A. FIGS. 3A and 3B may demonstrate how a personalization may be achieved through replacement of individual components of a content item, for example a thumbnail image or a title, or through replacement of a complete content item including all of its components.

In some alternative embodiments, the personalization may comprise replacing more than one content item, replacing, adding or changing a presentation style of a content item, replacing a section with an alternative section comprised of new content items, CMS-served content items, or any combination thereof.

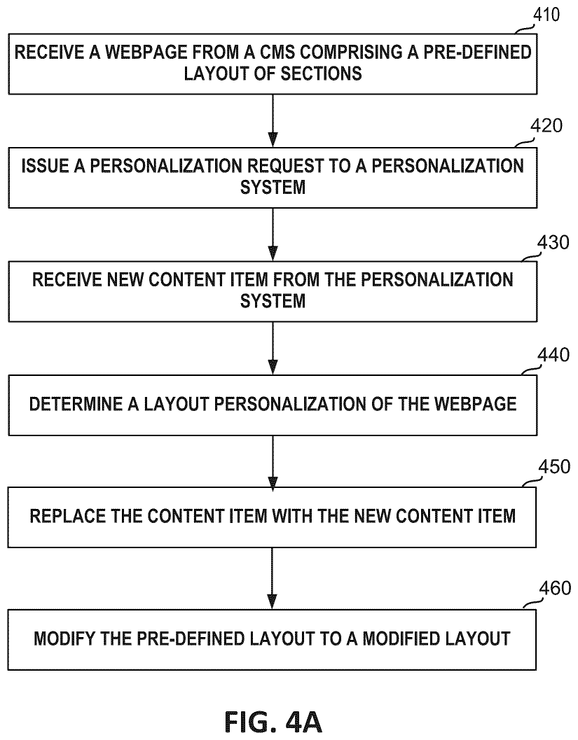

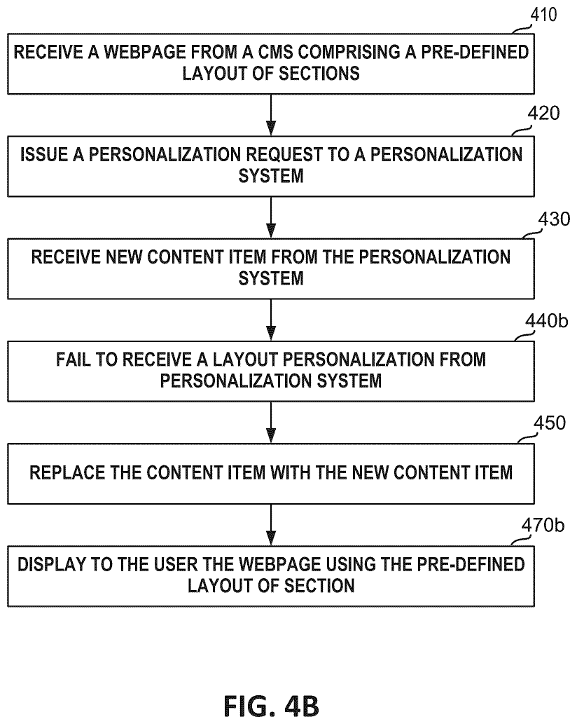

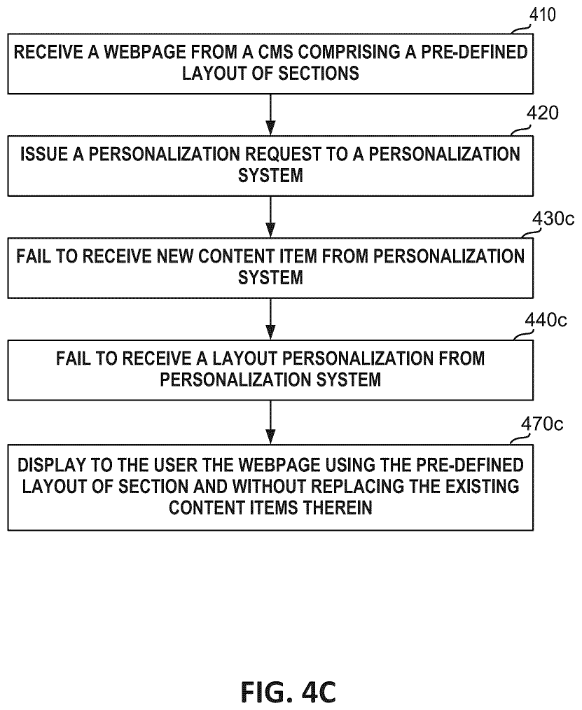

Referring now to FIG. 4A, a flowchart illustrates a method of layout personalization, in accordance with some exemplary embodiments of the disclosed subject matter.

FIG. 4A provides an overview of the enhanced personalization method, which includes not only content replacement but also layout modification. The client receives a CMS-served page, interacts with the personalization system, replaces content, and rearranges sections to form a modified layout. This diagram demonstrates how user affinity scores influence both content selection and layout.

In Step 410, a client device may receive a webpage from the CMS. The webpage may comprise a pre-defined layout of multiple sections, each section comprising at least one content item.

In Step 420, the client device may issue a personalization request to the personalization system. The personalization request may include information about the user, such as demographic information, technical information, behavioral information, historic information, or the like.

In Step 430, one or more new content items may be received by the client device in response to the personalization request. The content items may be selected by the personalization system. The selection may be based on a heuristic determination aimed at selecting the content items with the highest user affinity in each section.

In Step 440, a layout personalization may be determined. The layout personalization may involve rearranging sections, modifying a size of a section, altering the number of placeholders within a section, excluding a section, replacing a section with a different section, reducing the number of sections, adding to the number of sections, or any combination thereof. The layout personalization may be determined by the personalization system. The layout personalization may be based on a heuristic determination aimed at improving user affinity of the personalized webpage compared to the user affinity with the CMS-served webpage. In some cases, the determination may be based on past performance of users having similar characteristics to the user. For example, it may be determined that users similar to the user avoid reading the sports section. Accordingly, such section may be excluded. As another example, it may be determined that users similar to the user only read basketball articles in the sports section. Accordingly, and as there are only a two relevant basketball items, the sports section may be decreased in size to only include two content items. As another example, it may be determined that users similar to the user prefer the sports section over the news section. Accordingly, the layout determination may rearrange the sections such that the sports section is placed in a higher location than the news section.

In Step 450, the client device may replace one or more content items with one or more of the new content items received in Step 430.

In Step 460, the pre-defined layout may be modified in accordance with the determination in Step 440. The implementation of the layout modification may be performed by the client device. In some exemplary embodiments, the layout modification may be implemented together with the placement of the new content items (Step 450). Additionally, or alternatively, the layout modification may be performed before or after the placement of the new content items.

Referring now to FIG. 4B, showing a flowchart of a fallback process, in accordance with some exemplary embodiments of the disclosed subject matter.

This diagram illustrates a fallback mechanism where layout personalization is not received in time. The client defaults to displaying the CMS-provided layout. This diagram highlights system resilience.

As shown in FIG. 4B, Steps 410, 420 and 430 are executed, as described in FIG. 4A. In Step 440b, the client device fails to receive a layout personalization from the personalization system. In Step 450, content items are replaced with new content items received from the personalization system. In Step 470b, the original CMS-defined layout is displayed, including the new content items that replaced the CMS-served content items.

In some alternative implementations, the client device may have access to a backup layout policy or a default adaptive layout stored locally.

In some alternative implementations, in the event of failing to receive a layout personalization, the client device may display the CMS-served webpage without replacing content items with new content items.

Referring now to FIG. 4C, a fallback sequence is illustrated in accordance with some exemplary embodiments of the disclosed subject matter. This figure outlines a scenario where layout personalization and new content items are not available. This illustrates a fallback sequence where layout personalization is not obtained.

In Steps 410 and 420 the client device may receive a webpage and may issue a personalization request.

In Step 430c the client fails to receive content items.

In Step 440c the client device fails to receive layout personalization.

In Step 470c the client device may render the CMS-served webpage exactly as received, without altering its layout nor replacing any of its content items. It is noted that in some cases, the failure to receive new content items may be partial and some content items may be replaced with new content items while the others, though deemed “replaceable” may remain unchanged.

In some alternative implementations, the client device may engage a retry mechanism if the personalization system is slow to respond.

In some alternative implementations, the client device may send a notification of failure to receive content items, layout personalization, or both. The notification may be sent to the personalization system, a network administrator, or any other relevant destination. Alternatively or additionally, the client device may maintain registry logs of failed attempts to receive content items, layout personalization, or both.

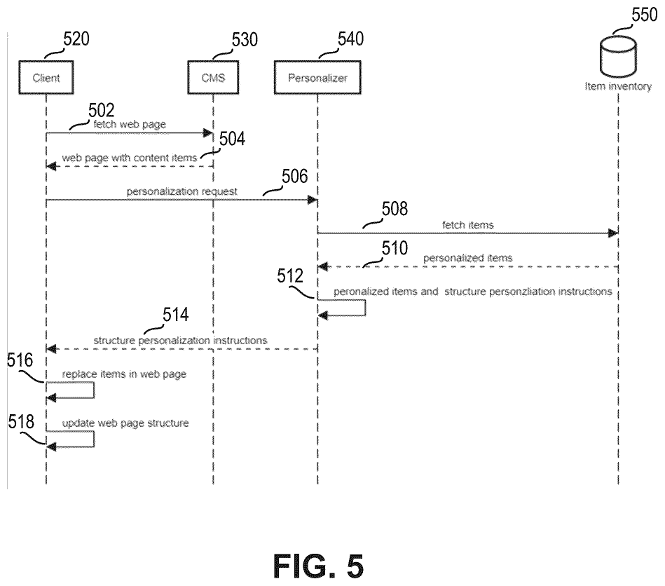

Referring now to FIG. 5, showing a sequence diagram of a method for personalizing content items and layout of a CMS-served webpage, in accordance with some exemplary embodiments of the disclosed subject matter. FIG. 5 may depict communication between the client device and the personalization system where the client sends a personalization request, receives new content and layout configuration, and modifies the pre-defined layout into the modified layout.

Client Device 520 sends Message 502 to CMS 530, which may request a webpage. CMS 530 may reply in Message 504 with a webpage comprising content items. This may be similar to Messages 202 and 208 of FIG. 2.

Client Device 520 may send Personalization Request 506 to Personalization System 540. This may be similar to Personalization Request 216 of FIG. 2. In some exemplary embodiments, Personalization Request 506 may indicate that the personalization may refer to replaceable content items and to the layout of the webpage.

Similarly to FIG. 2 (Messages 218, 220), Personalization System 540 may fetch new content items from Item Inventory 550 (508, 510).

In Step 512, Personalization System 540 may determine a modified layout plan along with new content items. In some alternative embodiments, the determining of the modified layout may be performed by the Client Device 520, a remote server, any other source, or any combination thereof.

Personalization System 540 may send Message 514 comprising new content items and a personalization plan to Client Device 520. In some embodiments, the new content items and the modified layout may be sent in separate messages (not shown).

In Step 516, the Client Device 520 may update or replace content items with new content items. This may be similar to Step 224 of FIG. 2.

In Step 518, Client Device 520 may implement the modified layout. As a result, the personalization of the webpage is implemented and a personalized webpage, including personalized content items and a personalized layout, is displayed to the user.

In some exemplary embodiments, the modified layout may be partially implemented by the client device, wherein parts of the modified layout are not implemented by the client device. For example, the client device may change the location of sections according to the layout personalization received from the personalization system but not change the size or style of the sections that were included in the layout personalization (not shown).

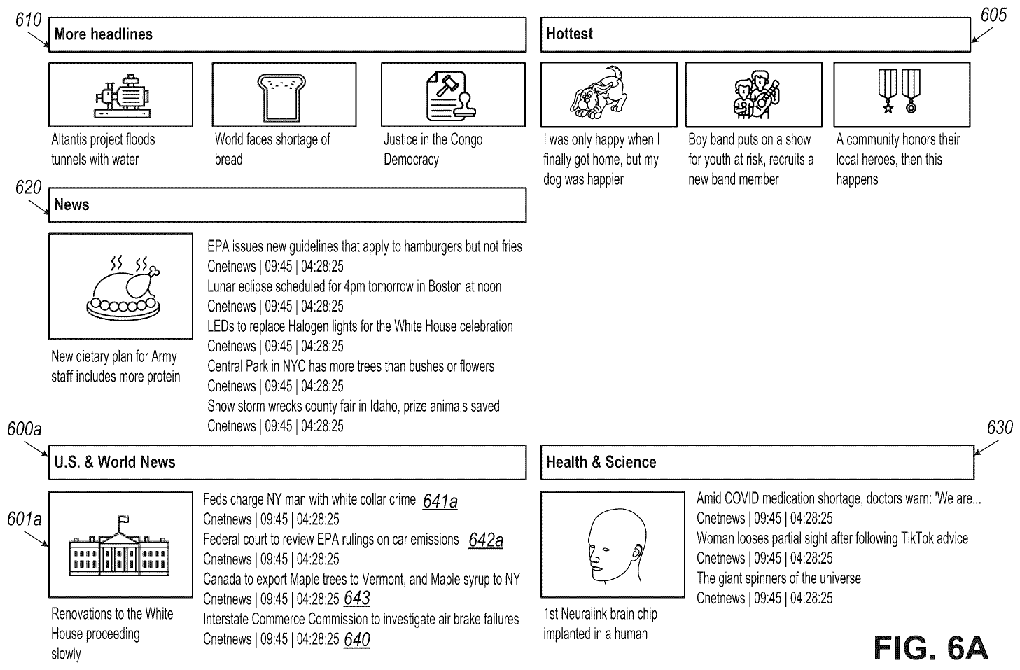

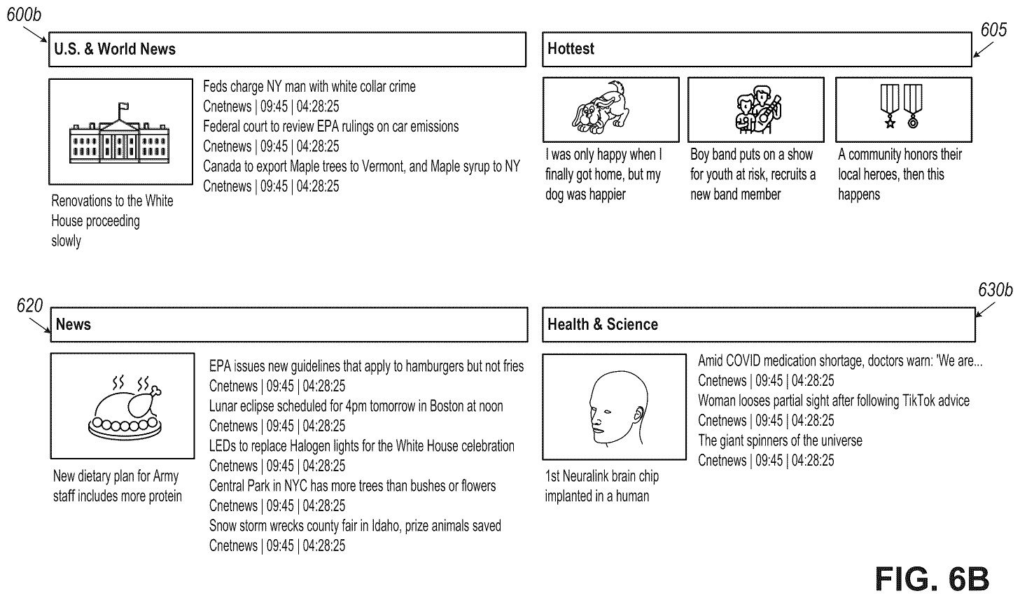

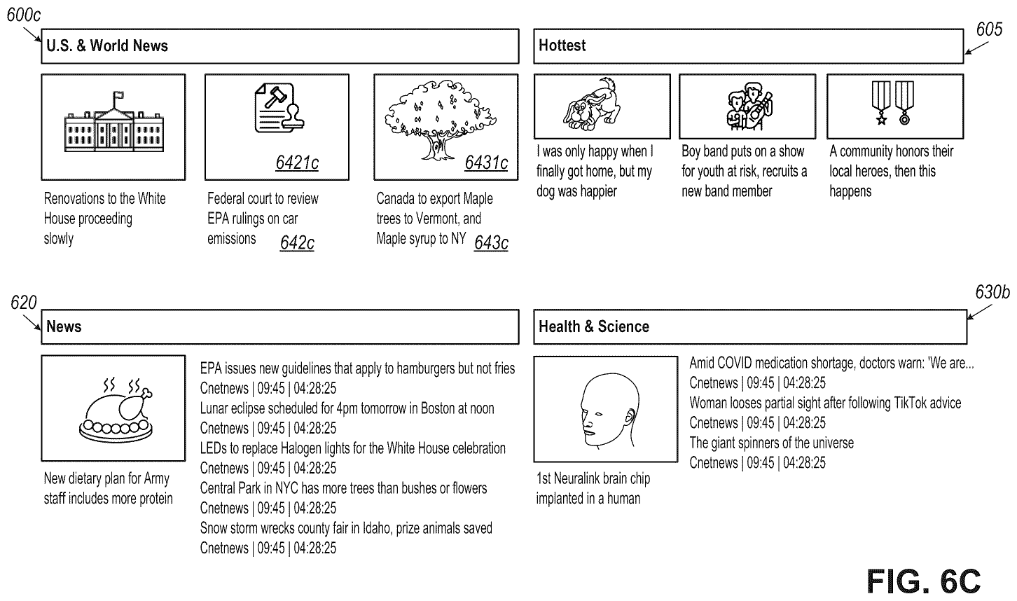

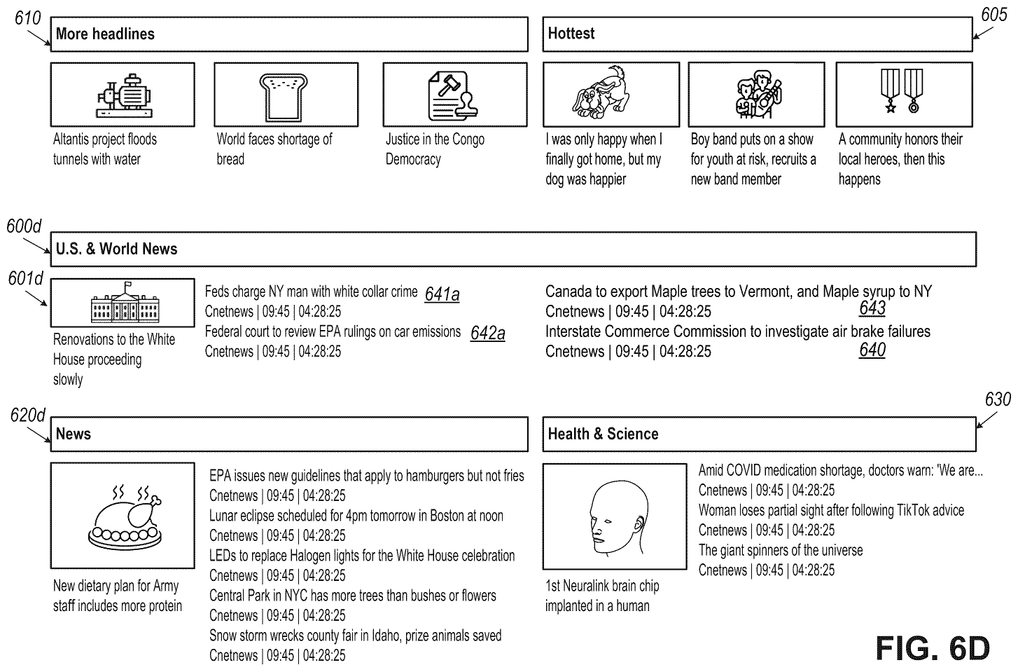

Referring now to FIG. 6A, illustrating an exemplary CMS served webpage prior to personalization, in accordance with some exemplary embodiments of the disclosed subject matter. FIG. 6A presents the CMS pre-defined layout of Sections 600a, 605, 610, 620, and 630. Section 605 may be identified as hand-curated. In some exemplary embodiments, hand-curated sections may maintain their presentation style. Additionally, or alternatively, hand-curated sections may remain unchanged with respect to the number of placement holders therein. In some cases, if a section is defined as “hand-curated”, all the content items therein may be deemed “hand-curated” as well. However, in other embodiments, a hand-curated section may include replaceable content items. In some cases, a hand-curated section may maintain its position within the arrangement defined by the layout. For example, a “hot topics” section, which may appear at the top of a newspaper homepage may be defined as “hand-curated” and may maintain its position during the layout personalization.

Section 600a may comprise content items 640, 641a, 642a, and 643, and thumbnail 601a.

Referring now to FIG. 6B, illustrating a modified layout of the webpage shown in FIG. 6A, in accordance with some exemplary embodiments of the disclosed subject matter. FIG. 6B illustrates a modified layout comprising rearrangement of sections, removal of a section, and removal of a content item in a relocated section. The removal of a content item from a relocated section may result from a different shape or number of content item placeholders in the new section location.

As shown in FIG. 6B, Section 610 of FIG. 6A is omitted.

As shown in FIG. 6B, Section 600a is promoted to a higher placement (600b) and Content Item 640 shown in FIG. 6A is omitted from Section 600b.

As shown in FIG. 6B, Section 630b is promoted to a higher placement compared to its placement in FIG. 6A (Section 630).

As shown in FIG. 6B, Hand-curated Section 605 is unchanged compared to FIG. 6A. Section 620 is also unchanged.

Referring now to FIG. 6C, illustrating a modified layout of the webpage shown in FIG. 6A, in accordance with some exemplary embodiments of the disclosed subject matter.

As shown in FIG. 6C, Section 610 is omitted.

As shown in FIG. 6C, Sections 605 and 620 are unchanged.

As shown in FIG. 6C, Section 630c is moved up.

As shown in FIG. 6C, Section 600c illustrates several modifications of Section 600a:
Section 600c is moved up;
Content items 641a and 640 of Section 600a in FIG. 6A are omitted from Section 600c in FIG. 6C;
Content item 642a in FIG. 6A is text only, corresponding Content Item 642c in FIG. 6C comprises text plus Thumbnail Image 6421c. The addition of the thumbnail image was required due to the change in presentation style of Section 600c.
Similarly, Content item 643a in FIG. 6A is text only, corresponding Content item 643c in FIG. 6C comprises text plus thumbnail picture 6431c; and
Section 630c is moved up.

Referring now to FIG. 6D, illustrating a modified layout of the webpage shown in FIG. 6A, in accordance with some exemplary embodiments of the disclosed subject matter. FIG. 6D illustrates that section 600d is moved up, and the section style may have been modified. The width of section 600d has been elongated to the width of the webpage (e.g., instead of half the webpage or one column), and the height of section 600d has been decreased. Whereas the height of section 600a could accommodate a stack of four content items shown in text-only modality, the height of section 600d can accommodate only a stack of two content items in text-only modality. In order to accommodate the modified section dimensions, the height of thumbnail content item 601d has been decreased. Additionally, or alternatively, the thumbnail image may be shrunk while maintaining the proportion of the original dimensions.

Section 620d is shifted downward. These modifications may reflect personalization not only in content but also in layout, where FIG. 6A illustrates a pre-defined layout, and FIG. 6D illustrates a modified layout.

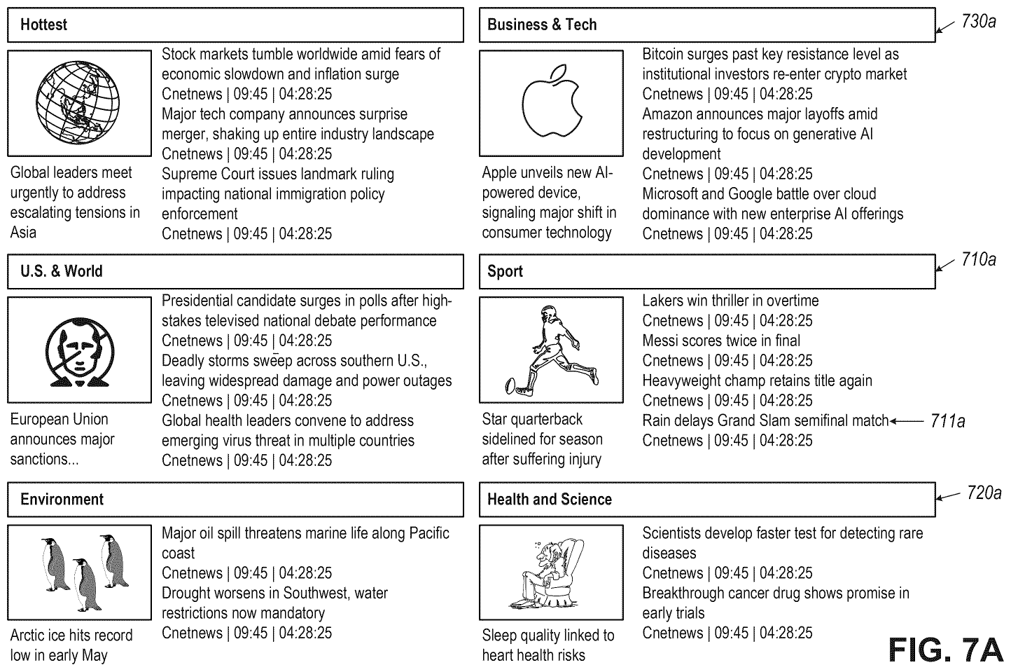

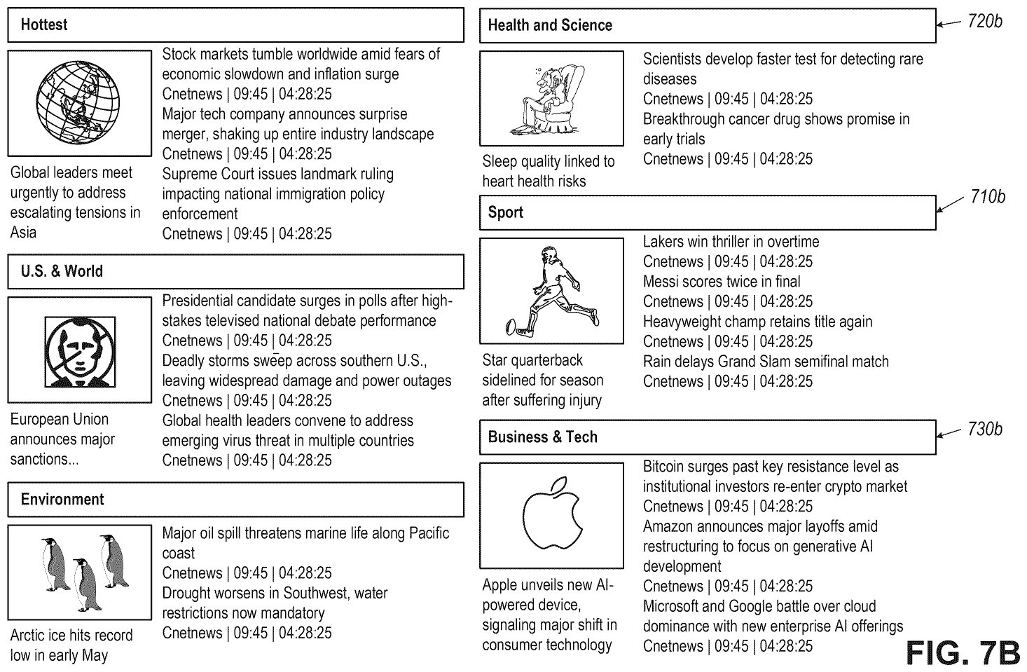

Referring now to FIG. 7A, showing a CMS served webpage, in accordance with some exemplary embodiments of the disclosed subject matter. In FIG. 7A, the CMS pre-defined layout comprises Sections 710a, 720a, and 730a.

Referring now to FIG. 7B, a modified layout of the webpage shown in FIG. 7A, in accordance with some exemplary embodiments of the disclosed subject matter. FIG. 7B illustrates a modified layout, without changes to content items.

As shown in FIG. 7B, Section 720b has been relocated to a position higher on the page, and Section 730b has been relocated to a position lower on the page. In some exemplary embodiments, the determination of the change in layout may have been responsive to a calculated higher user affinity for the category associated with Section 720a than the calculated user affinity associated with the category of Section 730a. Additionally, or alternatively, the determination of the change in layout may have been responsive to a calculated higher user affinity for the content items to be displayed in Section 720a than the calculated user affinity associated with the content items to be displayed in Section 730a

In some alternative embodiments, layout personalization, content personalization, or both, may comprise adaptation to specific user display device attributes, for example screen dimensions, screen orientation, dynamic change of screen orientation, mobile device vs. stationary, or any combination thereof.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
receiving, by a client device, a webpage from a Content Management System (CMS) to be displayed to a user, wherein the CMS is configured to generate the webpage to comprise a plurality of sections arranged in a pre-defined layout, wherein each section is associated with a section category, wherein each section comprising one or more content items that are associated with the section category;
the client device issuing a personalization request to a personalization system;
the client device receiving from the personalization system one or more new content items to replace one or more existing content items in the webpage, wherein the personalization system is configured to select the one or more new content items in response to receiving the personalization request;
determining a layout personalization of the webpage based on computed levels of user affinity of the user to the one or more new content items and to one or more non-replaced content items in the webpage;
the client device replacing the one or more existing content items in the webpage with the one or more new content items, whereby the webpage is modified to comprise the one or more new content items and the one or more non-replaced content items and to exclude the one or more existing content items; and
the client device implementing the layout personalization, wherein said implementing the layout personalization comprises modifying the pre-defined layout to a modified layout, whereby the plurality of sections, or portion thereof, are arranged in the modified layout, the modified layout is different than the pre-defined layout.

2. The method of claim 1, wherein said determining is performed by the personalization system prior to the client device receiving from the personalization system the one or more new content items.

3. The method of claim 2, wherein the client device receives the layout personalization from the personalization system together with the one or more new content items.

4. The method of claim 2 further comprising:
receiving, by the client device, a second webpage from the CMS;
the client device issuing a second personalization request to the personalization system, wherein the personalization system is configured to determine a second layout personalization for the second webpage;
upon the client device failing to receive the second layout personalization from the personalization system, the client device displaying the second webpage without modifying an original layout of the second webpage.

5. The method of claim 1, wherein the client device implementing the layout personalization causes the webpage to not present a new content item from the one or more new content items, whereby a modified webpage that is displayed to the user is absent of the new content item.

6. The method of claim 5, wherein the new content item is associated with a specific section category, wherein the new content item is not presented by the webpage due to the modified layout comprising fewer content item placeholders to present content items compared to the pre-defined layout with respect to a section that is associated with the specific section category.

7. The method of claim 5, wherein the new content item is associated with a specific section category, wherein the new content item is not presented by the webpage due to the modified layout excludes a section having the specific section category.

8. The method of claim 1, wherein the pre-defined layout comprises a first arrangement of the plurality of sections within a screen display, wherein the modified layout comprises a second arrangement of the plurality of sections within the screen display, the second arrangement is different from the first arrangement.

9. The method of claim 1, wherein the pre-defined layout comprises a number of the plurality of sections, wherein the modified layout comprises a smaller number of sections, whereby the modified layout excludes at least one section that is included in the pre-defined layout.

10. The method of claim 1, wherein the pre-defined layout comprises a first section associated with a section category, wherein the modified layout comprises a second section associated with the section category, wherein the first section comprising a different number of content item placeholders compared to the second section.

11. The method of claim 1, wherein the pre-defined layout comprises a first section associated with a section category, wherein the pre-defined layout defines a presentation style for the first section, wherein the modified layout comprises a second section associated with the section category, wherein the modified layout defines a different presentation style for the second section.

12. The method of claim 11, wherein the presentation style comprises at least one presentation attribute, the presentation attribute is selected from a list consisting of:
content item placeholder dimensions;
a thumbnail image dimensions within a content item placeholder;
vertical or horizontal arrangement of content item placeholders;
internal layout within a content item placeholder defining relative position between at least a thumbnail image of a content item and title of the content item.

13. The method of claim 1, wherein the plurality of sections comprises a hand-curated section, wherein the layout personalization is constrained from changing a presentation style of the hand-curated section and from changing a location of the hand-curated section within the webpage.

14. The method of claim 1 further comprising receiving, by the client device, a second webpage from the CMS, the second webpage comprising at least existing content items, the client device issuing a second personalization request to the personalization system, wherein upon the client device failing to receive new content items in response to the personalization request, the client device displaying the second webpage without replacing the existing content items.

15. A computerized system comprising:
a Content Management System (CMS);
a client device of a user; and
a personalization system;
wherein said CMS is configured to generate a webpage comprising a plurality of sections arranged in a pre-defined layout, wherein each section is associated with a section category, wherein each section comprises one or more content items that are associated with the section category;
wherein said client device is configured to:
receive the webpage from said CMS to be displayed to the user;
issue a personalization request to said personalization system;
receive from said personalization system one or more new content items to replace one or more existing content items in the webpage;
replace the one or more existing content items in the webpage with the one or more new content items, whereby the webpage is modified to comprise the one or more new content items and one or more non-replaced content items and to exclude the one or more existing content items; and
implement a layout personalization by modifying the pre-defined layout to a modified layout, whereby the plurality of sections, or portion thereof, are arranged in the modified layout, the modified layout is different than the pre-defined layout;
wherein said personalization system is configured to:
select the one or more new content items in response to receiving the personalization request; and
determine the layout personalization of the webpage based on computed levels of user affinity of the user to the one or more new content items and to the one or more non-replaced content items in the webpage.

16. The computerized system of claim 15, wherein said client device is further configured to display the webpage without modifying the pre-defined layout in case of a failure to receive layout personalization instructions from said personalization system in response to the personalization request.

17. The computerized system of claim 15, wherein the pre-defined layout comprises a first arrangement of the plurality of sections within a screen display, wherein the modified layout comprises a second arrangement of the plurality of sections within the screen display, the second arrangement is different from the first arrangement.

18. The computerized system of claim 15, wherein the pre-defined layout comprises a number of the plurality of sections, wherein the modified layout comprises a smaller number of sections, whereby the modified layout excludes at least one section that is included in the pre-defined layout.

19. The computerized system of claim 15, wherein the pre-defined layout comprises a first section associated with a section category, wherein the modified layout comprises a second section associated with the section category, wherein the first section comprising a different number of content item placeholders compared to the second section.

20. The computerized system of claim 15, wherein the pre-defined layout comprises a first section associated with a section category, wherein the pre-defined layout defines a presentation style for the first section, wherein the modified layout comprises a second section associated with the section category, wherein the modified layout defines a different presentation style for the second section.
